(19) United States
(12) Patent Application Publication
(10) Pub. No.: US 2012/0111548 A1
(43) Pub. Date: May 10, 2012

(54) METHOD OF MAKING A HEAT EXCHANGER TUBE, AND HEAT EXCHANGER

(75) Inventors: Ingo Toparkus, Habichtswald (DE); Rainer Vösgen, Salzkotten (DE); Nicole Rotzoll, Paderborn (DE)

(73) Assignee: Benteler Automobiltechnik GmbH, Paderborn (DE)

(21) Appl. No.: 13/098,842

(22) Filed: May 2, 2011

(30) Foreign Application Priority Data
May 3, 2010 (DE) 102010019241.4-14

(51) Int. Cl. F28F 1/00; B23P 15/26

(52) U.S. Cl. 165/177; 29/890.053

(57) ABSTRACT

In a method of making a heat exchanger tube, a tube of circular cross section is shaped to a tube of non-circular cross section, such as for example rectangular cross section, and a waved configuration is imparted in longitudinal direction and/or transverse direction of the tube of non-circular cross section.

### CROSS-REFERENCES TO RELATED APPLICATIONS

This application claims the priority of German Patent Application, Serial No. 10 2010 019 241.4-14, filed May 3, 2010, pursuant to 35 U.S.C. 119(a)-(d), the content of which is incorporated herein by reference in its entirety as if fully set forth herein.

### BACKGROUND OF THE INVENTION

The present invention relates to a method of making a heat exchanger tube, and to a heat exchanger.

The following discussion of related art is provided to assist the reader in understanding the advantages of the invention, and is not to be construed as an admission that this related art is prior art to this invention.

When designing heat transfer devices or heat exchangers for motor vehicles, heat transfer capability has to be taken into account in order to comply with increasingly stricter regulations as more efficient fuel consumption of combustion engines and increasingly stricter exhaust emissions are demanded.

In particular when cooling exhausts during exhaust gas recirculation to an engine are involved, ever increasing heat output has to be carried off in order to attain a high degree of charging of the cylinder charge. Also other heat exchangers, such as for example oil cooling systems, charge-air cooling systems, or cooling circuit heat exchangers have increasingly to comply with stricter requirements as far as heat transfer capability is concerned.

In addition to the stricter requirements with respect to heat transfer capability, heat exchangers should also operate at increasingly higher pressures. In particular heat exchangers which are flowed through by a gaseous fluid to be cooled, increasingly higher engine supercharging stages require more pressure to be transferred. Moreover, a smaller pressure loss is increasingly demanded within the heat exchanger.

In order to reduce CO₂ emissions of motor vehicles, there is also a demand for better aerodynamics of vehicle bodies, which results in a decrease in size of cooling openings. This adversely affects the overall cooling capacity of the heat exchanger. At the same time, the total weight of the vehicle should decrease to lower fuel consumption and thus CO₂ emission. These weight-reducing demands are equally true for individual components of the vehicle.

It would therefore be desirable and advantageous to provide an improved method of making a heat exchanger tube, and an improved heat exchanger to obviate prior art shortcomings and to realize high cooling capacity while yet reducing flow resistance and attaining a compact size.

### SUMMARY OF THE INVENTION

According to one aspect of the present invention, a method of making a heat exchanger tube includes the steps of shaping a tube of circular cross section to a tube of non-circular cross section, and imparting a waved configuration in longitudinal direction and/or transverse direction of the tube of non-circular cross section.

The method according to the present invention has the advantage that the manufactured heat exchanger tube is compact in size and exhibits superior pressure tightness. A generally circular tube, e.g. a rolled longitudinally welded tube, is transformed by a forming process to a tube having a non-circular cross section. Examples of a non-circular cross section include oval, elliptic, rectangular cross sections and/or combinations thereof. Currently preferred is a rectangular cross section. The thus produced non-circular tubular section has a substantially same pressure resistance comparable to a tubular section of round configuration. In the following description, the initially circular tube is referred to a round tube profile.

In a further method step, which may be implemented staggered in time after formation of the non-circular tube or also simultaneously therewith, the heat exchanger tube is provided with a waved configuration in longitudinal direction and/or transverse direction. In relation to the X axis defining the longitudinal direction, the waved configuration may have an amplitude which is directed in the form of the Y axis as well as Z axis. It is equally conceivable to provide a combination of the configuration in Y and Z directions. The waved configuration may also be imparted in transverse direction of the heat exchanger tube. As a result, the tube of non-circular cross section may generally have a cross section of U-shaped or S-shaped configuration.

This results in the benefit that the heat exchanger tube has a greater surface area while retaining its dimension in longitudinal direction. The waved configuration in longitudinal direction results in a heat exchanger that runs more efficiently than a heat exchanger with straight heat exchanger tubes while having substantially constant pressure loss over the length of the heat exchanger tube.

According to another advantageous feature of the present invention, the waved configuration can be imparted at an amplitude which is 0.2 to 1.2 times a dimension of an outer diameter of the round tube profile. Currently preferred is an amplitude which is 0.5 to 0.75 times the outer diameter of the round tube profile. The amplitude corresponds hereby to the respective deflection of the waved configuration in Y and Z directions. As a consequence, pressure loss is slight when a fluid flows through the heat exchanger tube and a thorough mixture of the exhaust gas in the heat exchanger tube is realized while keeping the flow resistance to a minimum.

According to another advantageous feature of the present invention, the waved configuration can be imparted at a wavelength which is 1 to 7 times the outer diameter of the round tube profile. Currently preferred is a wavelength which is 3 to 6 times the outer diameter of round tube profile. Also in this way, the cooling capacity is high and a better surface utilization as well as improved mixture of the exhaust gas is realized in the heat exchanger tube while the flow resistance is kept to a minimum.

According to another advantageous feature of the present invention, the tube may be made of high-quality steel. The term “high-quality steel” relates hereby essentially to stainless steel. Also conceivable is the use of austenitic steel. The use of such steel material is advantageous because corrosion resistance complies with stringent requirements demanded for an exhaust tract of a vehicle. The heat exchanger is circulated by chemically aggressive coolants, such as for example cooling water with cooling additives, on the one hand, and by corroding exhausts, on the other hand.

Furthermore, the heat exchanger is subject to intense thermal fluctuations. The steel provides superior heat conductivity which is transferred through convection and heat conduction within the heat exchanger from one medium to another so that the heat exchanger operates with high efficiency. The use of high-quality steel thus affords the heat exchanger with a long service life.

According to another advantageous feature of the present invention, the tube can be made of a high-quality steel alloy having the following alloying elements, expressed in weight-%:

| | |
|---|---|
| Carbon (C) | max. 0.08 |
| Silicon (Si) | max. 1.0 |
| Manganese (Mn) | max. 2.2 |
| Phosphorus (P) | max. 0.045 |
| Sulfur (S) | max. 0.03 |
| Chromium (Cr) | 16.5 to 21.0 |
| Nickel (Ni) | 8.0 to 26.0, |
| remainder iron (Fe). | |

According to another advantageous feature of the present invention, the high-quality steel alloy may include, expressed in weight-%, at least one of the alloying elements selected from the group consisting of:

| | |
|---|---|
| Nitrogen (N) | max. 0.15 |
| Molybdenum (Mo) | 2.0 to 5.0 |
| Titanium (Ti) | max. 0.7 |
| Copper (Cu) | 1.2 to 2.0. |

### Examples

A heat exchanger tube can be made of a high-quality steel alloy having the following alloying elements, expressed in weight-%:

Alloy 1:

| | |
|---|---|
| Carbon (C) | max. 0.07 |
| Silicon (Si) | max. 1.0 |
| Manganese (Mn) | max. 2.0 |
| Phosphorus (P) | max. 0.045 |
| Sulfur (S) | max. 0.03 |
| Nitrogen (N) | max. 0.11 |
| Chromium (Cr) | 17.5 to 19.5 |
| Nickel (Ni) | 8.0 to 10.5, |
| remainder iron (Fe). | |

Alloy 2:

| | |
|---|---|
| Carbon (C) | max. 0.03 |
| Silicon (Si) | max. 1.0 |
| Manganese (Mn) | max. 2.0 |
| Phosphorus (P) | max. 0.045 |
| Sulfur (S) | max. 0.03 |
| Nitrogen (N) | max. 0.11 |
| Chromium (Cr) | 18.0 to 20.0 |
| Nickel (Ni) | 10.0 to 13.0, |
| remainder iron (Fe). | |

Alloy 3:

| | |
|---|---|
| Carbon (C) | max. 0.03 |
| Silicon (Si) | max. 1.0 |
| Manganese (Mn) | max. 2.0 |
| Phosphorus (P) | max. 0.045 |
| Sulfur (S) | max. 0.03 |
| Nitrogen (N) | max. 0.11 |
| Chromium (Cr) | 17.5 to 19.5 |
| Nickel (Ni) | 8.0 to 10.5, |
| remainder iron (Fe). | |

Alloy 4:

| | |
|---|---|
| Carbon (C) | max. 0.03 |
| Silicon (Si) | max. 1.0 |
| Manganese (Mn) | max. 2.0 |
| Phosphorus (P) | max. 0.045 |
| Sulfur (S) | max. 0.03 |
| Nitrogen (N) | max. 0.11 |
| Chromium (Cr) | 16.5 to 18.5 |
| Molybdenum (Mo) | 2.0 to 2.5 |
| Nickel (Ni) | 10.0 to 14.5, |
| remainder iron (Fe). | |

Alloy 5:

| | |
|---|---|
| Carbon (C) | max. 0.08 |
| Silicon (Si) | max. 1.0 |
| Manganese (Mn) | max. 2.0 |
| Phosphorus (P) | max. 0.045 |
| Sulfur (S) | max. 0.03 |
| Chromium (Cr) | 16.5 to 18.5 |
| Molybdenum (Mo) | 2.0 to 2.5 |
| Nickel (Ni) | 10.5 to 13.5 |
| Titanium (Ti) | max. 0.7, |
| remainder iron (Fe). | |

Alloy 6:

| | |
|---|---|
| Carbon (C) | max. 0.02 |
| Silicon (Si) | max. 0.7 |
| Manganese (Mn) | max. 2.0 |
| Phosphorus (P) | max. 0.03 |
| Sulfur (S) | max. 0.01 |
| Chromium (Cr) | 19.0 to 21.0 |
| Molybdenum (Mo) | 4.0 to 5.0 |
| Nickel (Ni) | 24.0 to 26.0 |
| Nitrogen (N) | max. 0.15, |
| Copper (Cu) | 1.2 to 2.0 |
| remainder iron (Fe). | |

According to another aspect of the present invention, an exhaust-gas conducting heat exchanger includes a plurality of tubes, each tube having a non-circular cross section and formed with a waved configuration in longitudinal direction and/or transverse direction of the tube of non-circular cross section.

An exhaust-gas conducting heat exchanger in accordance with the present invention can be produced in a cost-efficient and reliable manner and has a large contact surface between the heat-carrying fluid and the heat-dissipating fluid. The result is a greater heat capacity which is realized as a result of an extension of the flow path as well as turbulences within the flowing fluid and swirling. This is realized in dependence on the arrangement of the exhaust-gas conducting heat exchanger on both sides of the used fluid, regardless whether the fluid flows for example in same direction, opposite directions, or crossing directions.

According to another advantageous feature of the present invention, the heat exchanger tube can have a varying wavelength or varying amplitude in longitudinal direction of the tube. In this way, turbulences generated by the waved configuration can be varied in the flow channel so as to be able to optimize developing pressure losses or contact regions in the form of laminar flow. This has the advantage that the heat exchanger operates efficiently in the presence of high turbulence, caused by a strong flow channel waviness, even when the temperature differential between the two fluids flowing through the heat exchanger is slight.

The heat exchanger tube according to the present invention may be configured in relation to the extension of the waved configuration in longitudinal direction in two dimensions, e.g. in the form of a helix. Also conceivable is a configuration of the heat exchanger tubes in the form of a double helix.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a side view of a heat exchanger tube according to the present invention;

FIG. 2 is a perspective illustration of a heat exchanger tube according to the present invention;

FIG. 3 is a side view of an exhaust-gas conducting heat exchanger according to the present invention;

FIG. 4 is a cross sectional view of a circular tube; and

FIG. 5 is a side view of a heat exchanger tube according to the present invention with geometrical dimensioning.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

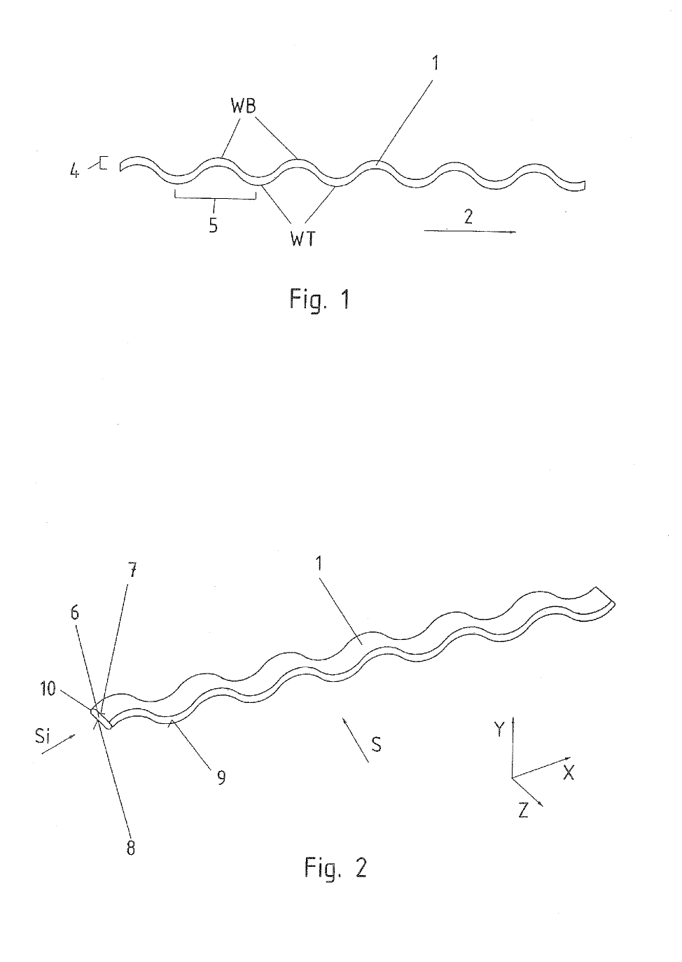

Turning now to the drawing, and in particular to FIG. 1, there is shown a side view of a heat exchanger tube 1 according to the present invention. The heat exchanger tube 1 has a waved configuration in longitudinal direction as indicated by arrow 2. The waved configuration has, in relation to the drawing plane, in vertical direction a projection in the form of an amplitude 4 and in horizontal direction a wave length 5. The wavelength 5 is hereby defined by the distance from wave valley WT to wave valley WT or wave peak WB to wave peak WB.

As can be seen in FIG. 2, which shows a perspective illustration of the heat exchanger tube 1, the heat exchanger tube 1 has a substantially rectangular cross section 6 defining a topside 7 and a bottom side 8, which in the non-limiting example shown here, are respectively configured flat in relation to the drawing plane. Side walls 9 of the heat exchanger tube 1 have a curvature 10.

Depending on the application, for example in the case of a cross-flow heat exchanger, the curvature 10 may have a positive effect on the flow S and resultant flow resistance. In the non-limiting example shown here, the inner flow direction Si, as relating to the coordinate system, is directed substantially in X direction and the amplitude 4 in Y direction. The heat exchanger tube 1 has a width b. Currently preferred is a width b of 0.5 to 12.0 mm.

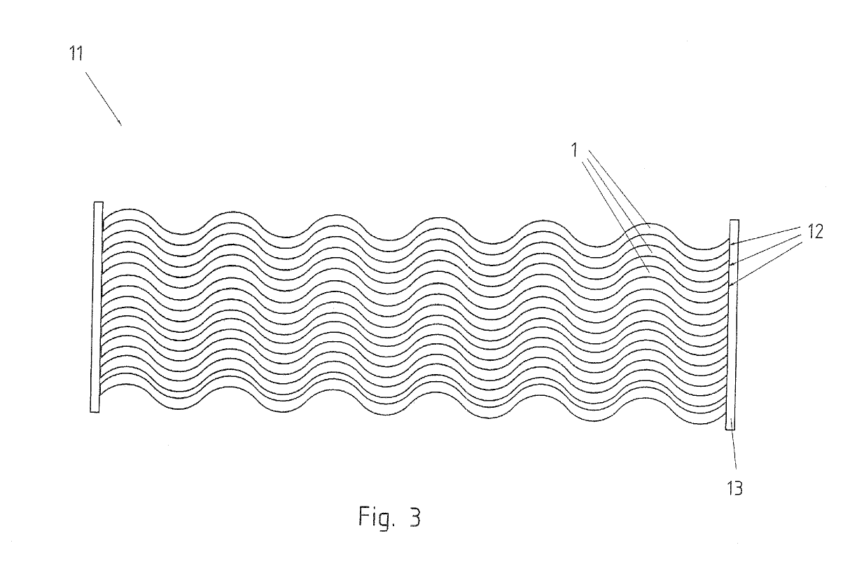

FIG. 3 shows a side view of an exhaust-gas conducting heat exchanger according to the present invention, generally designated by reference numeral 11. The heat exchanger 11 includes a plurality of interconnected heat exchanger tubes 1 which are coupled to one another at their ends 12 via tube bottoms 13. Coupling the ends 12 of the heat exchanger tubes 1 with the tube bottoms 13 may be realized by a formfit, interference fit, or also material joint in a respective end region of the heat exchanger tube 1. The heat exchanger tubes 1 are arranged in such a way that the wave valleys of neighboring heat exchanger tubes 1 lie in a plane. The tubes are thus not arranged at an offset to one another in longitudinal direction. This provides a high packing density.

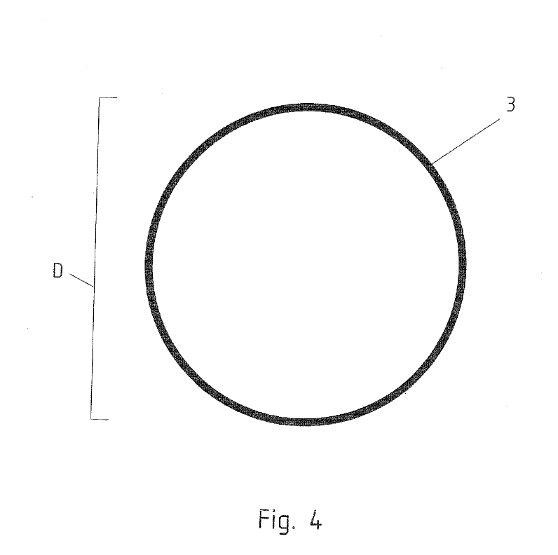

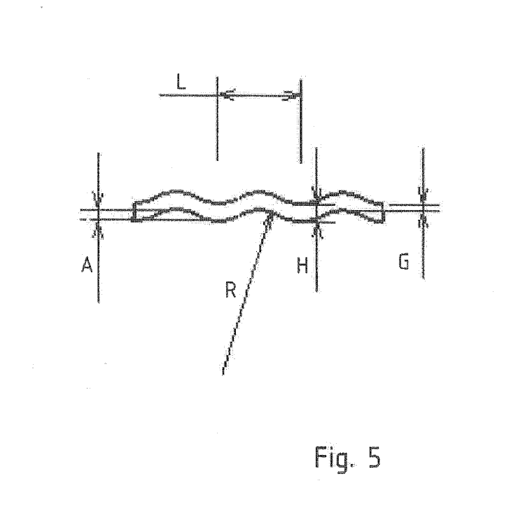

FIG. 4 shows a cross sectional view of a circular tube 3. In the initial state, the circular tube 3 has an outer diameter D. The circular tube 3 represents a semifinished product used in the manufacture of the heat exchanger tube 1 and thus is respectively flattened and formed with a waved configuration in the process. Amplitude 4 and wavelength 5 of the waved configuration are defined in relation to the outer diameter D.

FIG. 5 shows a side view of a heat exchanger tube 1 according to the present invention, depicting the wavelength L (designated in the other figures with reference numeral 5), height of the overall tube H, radius of a wave valley R, flow base zone G, and a simple wave height A. In accordance with the invention, a combination of good flow characteristics, good heat exchanger efficiency, and good space utilization is attained, when implementing at least one of the geometric conditions referred to in the following table:

| H/L | G = H − A | G/H | R/H |
|---|---|---|---|
| 0.1 to 0.3 | −4 to 2 mm | −1 to 1 | 1 to 5 |

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making a heat exchanger tube, comprising the steps of:
shaping a tube of circular cross section to a tube of non-circular cross section; and
imparting a waved configuration in longitudinal direction and/or transverse direction of the tube of non-circular cross section.

2. The method of claim 1, wherein the tube of non-circular cross section has a rectangular cross section.

3. The method of claim 1, wherein the waved configuration is imparted during or after the shaping step.

4. The method of claim 1, wherein the waved configuration is imparted at an amplitude which is 0.2 to 1.2 times an outer diameter of the tube of circular cross section.

5. The method of claim 1, wherein the waved configuration is imparted at an amplitude which is 0.5 to 0.75 times an outer diameter of the tube of circular cross section.

6. The method of claim 1, wherein the waved configuration is imparted at a wavelength which is 1 to 7 times an outer diameter of the tube of circular cross section.

7. The method of claim 1, wherein the waved configuration is imparted at a wavelength which is 3 to 6 times an outer diameter of the tube of circular cross section.

8. The method of claim 1, wherein the tube is made of high-quality steel.

9. The method of claim 1, wherein the tube is made of a high-quality steel alloy comprising as alloying elements, expressed in weight-%:

| | |
|---|---|
| Carbon (C) | max. 0.08 |
| Silicon (Si) | max. 1.0 |
| Manganese (Mn) | max. 2.2 |
| Phosphorus (P) | max. 0.045 |
| Sulfur (S) | max. 0.03 |
| Chromium (Cr) | 16.5 to 21.0 |
| Nickel (Ni) | 8.0 to 26.0, |
| remainder iron (Fe). | |

10. The method of claim 9, wherein the high-quality steel alloy includes, expressed in weight-%,: at least one of the alloying elements selected from the group consisting of:

| | |
|---|---|
| Nitrogen (N) | max. 0.15 |
| Molybdenum (Mo) | 2.0 to 5.0 |
| Titanium (Ti) | max. 0.7 |
| Copper (Cu) | 1.2 to 2.0. |

11. An exhaust-gas conducting heat exchanger, comprising a plurality of tubes, each tube having a non-circular cross section and formed with a waved configuration in longitudinal direction and/or transverse direction of the tube of non-circular cross section.

12. The exhaust-gas conducting heat exchanger of claim 11, wherein the tube has a wavelength which varies in longitudinal direction of the tube.

13. The exhaust-gas conducting heat exchanger of claim 11, wherein the tube has an amplitude which varies in longitudinal direction of the tube.

14. The exhaust-gas conducting heat exchanger of claim 11, wherein the tube has a waved configuration in the form of a helix.

15. The exhaust-gas conducting heat exchanger of claim 11, wherein the tube has a waved configuration in the form of a double helix.

16. The exhaust-gas conducting heat exchanger of claim 11, wherein the tube has a width of 0.5 to 12.0 mm.
